(19) United States
(12) Patent Application Publication
(10) Pub. No.: US 2002/0157931 A1
(43) Pub. Date: Oct. 31, 2002

(54) Circuit breaker lockout apparatus

(76) Inventor: Charles K. Smith, Hollywood, FL (US)

Correspondence Address: Richard M. Saccocio, P.A., Suite 301, 150 S.E. 12th Street, Ft. Lauderdale, FL, 33316, US

(21) Appl. No.: 09/843,903

(22) Filed: Apr. 27, 2001

(51) Int. Cl. H01H 9/26

(52) U.S. Cl. 200/50.33

(57) ABSTRACT

A lockout member is slidable between two positions where one position allows an electrical switch or a circuit breaker to be activated and a second position prevents activation of the switch or circuit breaker. The lockout member includes a downward extending portion which, depending upon the position of the lockout, provides for the ability to activate or deactivate the switch or circuit breaker.

### BACKGROUND OF THE INVENTION

1. Field of the Invention

This invention relates in general to the field of electrical power delivery apparatus and in particular to the field of lockout apparatus for delivery of electrical power to a use location.

2. Description of the Prior Art

Delivery of electrical power to an end use location typically involves the transmission of electricity from a generating station to a power distribution station, through high voltage transmission lines to a transformer and then to an end use location which generally comprises a bus bar of an electrical box. A plurality of individual circuits is then connected, through circuit breakers, to the electrical box bus bar. Generally, the electrical amperage delivered to the electrical box bus bar is equal to the sum total of the amperage or load to be serviced by the electrical box. The sum total of the amperage rating of the circuit breakers interposed between the bus bar and the individual circuits serviced by the electrical box may however, be more than the rated amperage of the lines to the electrical box. Accordingly, it is imperative that the system does not allow electrical energy to be drawn by the individual circuits that exceeds the load rating of the lines to the electrical box. This is usually accomplished by interposing a fuse between the electrical lines to the box and the bus bar of the electrical box with the fuse being rated at the load to be serviced by the electrical lines. Ideally then, if the service load is to be 100 amps, the lines to the electrical box are rated at 100 amps and the main fuse is also rated at 100 amps.

In the prior art, there exist arrangements where it is desired to increase the load rating of the sum of the individual circuits to a rating higher than the rating of the electrical lines to the box and the rating of the main fuse. For example, the sum of the individual circuits may be 120 amps while the electrical input or feeder lines to the electrical box and the main fuse are each rated for 100 amps. Obviously it is not permissible to draw the full 120 amps in this example. In the prior art therefore, provision is made to limit the service load to 100 amps. This usually takes the form of an expensive double throw switch arranged such that only one of two individual circuits can be powered at any one time. For example, if two of the above circuits each draw 20 amps, the double throw switch is wired to allow one of, but not both of, the 20 amp circuits to be powered at any one time. In this manner the total service load is limited to 100 amps. Without the double throw switch, there would be the possibility that both of the 20 amp electrical circuits would be powered at the same time which, of course, would overload the 100 amp electrical feed lines. The only way to eliminate the use of a double throw switch in such an example, would be to use a separate 10 amp circuit breaker for each of the two 20 amp circuits; but then, there would not be sufficient electrical power supplied to either of the two 20 amp circuits. In the prior art therefore, the only solution to providing power to two separate electrical circuits where the sum total of the amperage of the two circuits would cause the service load to exceed the power rating of the electrical box is to use an expensive double throw switch.

In lieu of the use of a double throw switch, the only other resolution of such a problem is to rewire the lines to the electrical box to increase the delivery load to 120 amps. This resolution however, does not solve the problem but rather incurs the expense of upgrading the entire electrical supply and delivery arrangement.

What is needed then is apparatus that eliminates the use and need of a double throw switch in an electrical arrangement where the sum total of the service load exceeds the total rating of the electrical power delivery apparatus.

In the prior art, expensive double throw switches are also used where an electrical box is connected in parallel to an electrical utility power source and to a backup power source. Both of which comprise power input apparatus to a single electrical box. In this example, the double pole double throw switch is used ahead of the circuit breakers such that in one position, the breakers are supplied by the electrical power company power and in the other position of the switch, the backup generator supplies the power to the circuit breakers. As in the previous prior art example, it would be advantageous to eliminate the need to use an expensive double throw switch.

### SUMMARY OF THE INVENTION

The present invention accomplishes the above-stated objectives as well as others, as may be determined by a fair reading and interpretation of the entire specification herein in which:

One embodiment of the present invention comprises circuit breaker lock-out apparatus adapted for use with a plurality of circuit beakers which prevent the use of a combination of circuit breakers from exceeding the power capacity of the input wiring. A slideable plate is attached to the housing of the power distribution box and over the circuit beakers contained therein. The slidable plate includes a combination of openings, edges, and extending members arranged such that the total amperage capacity of the circuit breakers capable of being used at a given time does not exceed the capacity of the input electrical wiring.

In another embodiment of the present invention, the lockout apparatus is adapted for use with circuit breakers where two or more alternative power sources are input connected to distribution circuitry.

The above-stated objects as well as other objects which, although not specifically stated, but are intended to be included within the scope of the present invention, are accomplished by the present invention and will become apparent from the hereinafter set forth Detailed Description of the Invention, Drawings, and the claims appended herewith.

### BRIEF DESCRIPTION OF THE DRAWINGS

Various other objects, advantages, and features of the invention will become apparent to those skilled in the art from the following discussion taken in conjunction with the following drawings, in which:

FIG. 1 schematically illustrates the delivery of electrical power from a utility pole to an electrical distribution box to which the present invention may be applied;

FIG. 2 illustrates a frontal plan view of a portion of the electrical distribution box of FIG. 1 having a plurality of circuit breakers therein and to which one embodiment of the inventive lockout apparatus can be applied;

FIG. 3 illustrates a portion of an electrical box having one arrangement of a plurality of circuit breakers to which one embodiment of the present has been applied;

FIG. 4 illustrates an alternate embodiment of the embodiment of FIG. 3;

FIG. 5 illustrates a further embodiment of the embodiment of FIG. 3;

FIG. 6 illustrates a further embodiment of the embodiment of FIG. 4;

FIG. 7 illustrates yet another embodiment of the present invention;

FIG. 8 illustrates a power backup arrangement to which the advantages of the present invention can be applied; and,

FIG. 9 illustrates the application of the present invention to the circuit breakers of FIG. 8.

### DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

Reference is now made to the drawings, wherein like characteristics and features of the present invention shown in the various figures are designated by the same reference numerals.

Reference is now made to FIG. 1 which schematically illustrates a typical prior art arrangement of the delivery of electrical power from a utility power source to an electrical box. Typically, high voltage electricity is transmitted through power lines 11 attached to a utility pole 12 which is located relatively close to a point of delivery where the electrical power is to be used. A transformer 13 serves to reduce the high voltage transmitted through power lines 11 to, for example, 220 volts. The 220 volt electrical power is then transmitted through low power lines 14 to an electrical box 15 which may be attached to a side of a building 16 or perhaps to a free standing object. Intermediate voltage reduction apparatus from the high power lines to the transformer 13 may be used, but the same is not important to the present invention and, therefore, is not illustrated.

The electrical power delivered to the electrical distribution box 15 is divided into a plurality of individual circuits 17, 18, 19, and 20. The number of individual circuits can number more or less than the four illustrated, as is well known in the art. By way of example, the electrical box 15 may be attached to a residence, a commercial building, a dockside power pedestal, and other like objects 16. The individual circuits 17-20 are ultimately routed through, for example, a building, to one or more electrical outlets, to which a power consuming electrical device, such as a refrigerator, machinery, etc. can be connected.

In order to ensure that each of the individual circuits 17-20 are not overloaded, a circuit breaker is connected between each individual circuit 17-12 and a bus bar within the electrical box to which the low power electrical lines 14 are connected, as is well known in the art. If an individual circuit 17, 18, 19, or 20 is overloaded by attempting to draw more electricity than the rating of the circuit breaker, the circuit breaker automatically trips and breaks the connector form the bus bar to the respective individual circuit.

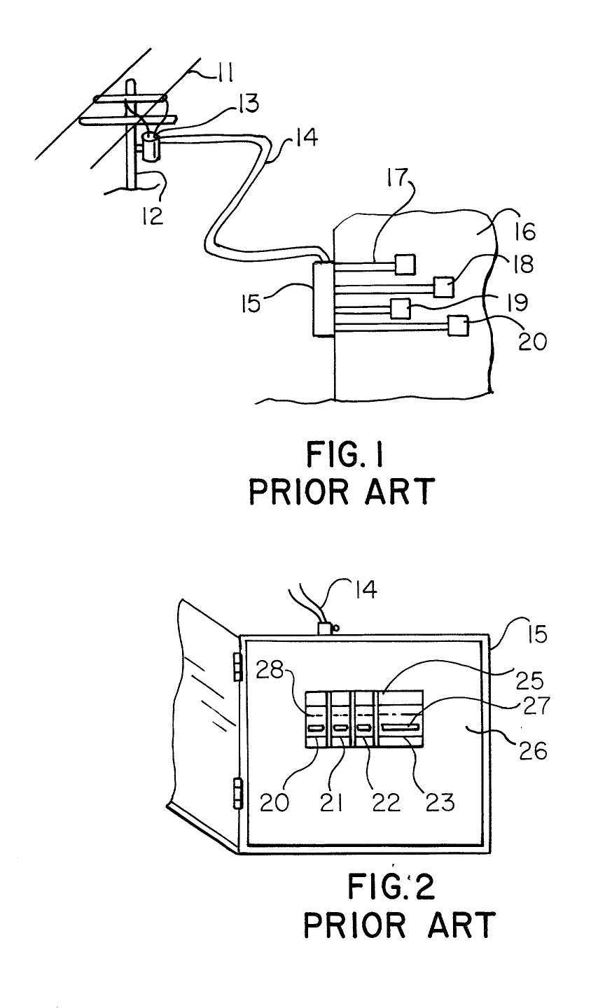

A typical circuit breaker arrangement as seen when the electrical box 15 is opened is illustrated in FIG. 2. In FIG. 2. the circuit breakers 21, 22, 23, and 24 are shown as being arranged side by side (alternatively, the circuit breakers can be arranged one above the other in an electrical box where the circuit breakers are arranged vertically) and may be separated by a thin metal strip 25. The thin metal strips 25, form part of a plate 26 which extends across the opening of the electrical box 15 and covers the electrical connections within the electrical box 15. It is to be noted that the side by side arrangement and the metal strips 25 are not material to the invention. Thus, the only electrical apparatus that is seen when electrical box 15 is opened are the front portions of the circuit breakers 21-23. The front portions of the circuit breakers 21-23 each include a lever 27 which can be moved from the illustrated connected position to an unconnected position 28. Should one or more of the circuit breakers 21-23 trip, it will automatically move the respective lever 27 to the unconnected position 28 which is readily observable by a person investigating the circuit failure.

In the prior art, in order to positively prevent overloading the power feed lines 14, the maximum amperage provided by the circuit breakers 17-20 is not to exceed the power rating of the feed power lines 14. For example, if the rated power of feed line 14 is 200 amps, the sum total of the power supplied by the circuit breakers 21-24 must be 200 amps or less, such as 15 amps, 50 amps, 75 amps, and 50 amps for breakers 21-24, respectively. Of course, other combinations are acceptable. As explained above, ideally, the power rating of the circuit breakers are consistent with the service load and if not, double throw switches must be used.

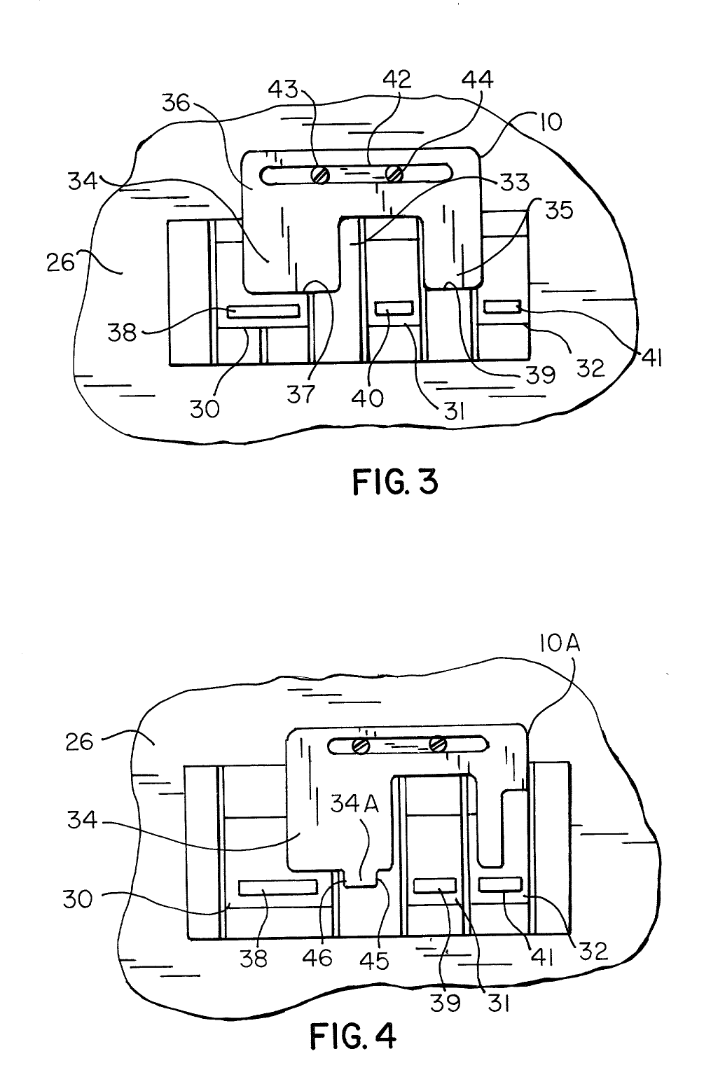

The present invention 10, however, allows the use of a plurality of circuit breakers 17-20 which exceed the power rating of feed line 14 without the use of double throw switches. One embodiment of the present invention is shown in FIG. 3. In FIG. 3, only those circuit breakers 30, 31, and 32 are shown. By way of example, circuit breaker 30 can be rated for 150 amps, while each of circuit breakers 31 and 32 can be rated for 50 amps for a total of 250 amps. The feed line 14 can be rated, as per the previous example, for 200 amps. Such an apparent overloading arrangement is permissible in accordance with a circuit beaker lockout 10 as provided herein.

The circuit breaker lockout 10 is slidingly attached to the cover of an electrical box 15, or to any other appropriate structure associated with the circuit breakers 30-32. Lockout 10 can be viewed as having a cutout 33 in the planar member comprising the lockout 10; or, can be viewed as having two spaced apart depending portions 34 and 35 from a common planar portion 36. In either event, the lower edge 37 of portion 34 extends to slightly above the top of lever 38 of circuit breaker 30 while the lower edge 39 of depending portion 35 extends to a position slightly above the top of levers 40 and 41 of breakers 31 and 32, respectively. The width of portions 34 and 35 and the width of cutout 33 are configured such that when edge 38 is over lever 38 of circuit breaker 30, edge 39 is positioned between breakers 31 and 32. This arrangement prevents lever 38 of breaker 30 from being moved to a circuit connecting position, but allows levers 4 and 41 of beakers 31 and 32, respectively, to be moved to circuit connecting positions. Thus, lockout 10, in the position shown, only allows 100 amps (50 from breaker 31 and 50 from breaker 32) to flow through feed line 14. Since the rating of feed line 14 is 200 amps, the feed line 14 is not overloaded.

When lockout 10 is moved to the right as shown in phantom in FIG. 3, the lower edge 37 clears lever 38 but is partially positioned over lever 40 while edge 39 is positioned over lever 41. In this position, lockout 10 only allows activation of circuit breaker 30, levers 40 and 41 are prevented from being moved. In this position, therefore, lockout 10 only permits 150 amps to flow through feed line 14. The ability of lockout 10 to move from one position to the other is controlled, in FIG. 3, by the length of cutout 42 and the position of attaching fasteners 43 and 44. This sliding configuration in conjunction with the configuration of depending portions 34 and 35 and cutout portion 33, provides for the above-described alternative activation of circuit breakers 30, 31, and 32. As an alternative to using a sliding motion to reposition the lockout 10. the lockout 10 can be fastened to the electrical box by appropriate fasteners that allow for removal and repositioning of the lockout 10 to another position relative to the circuit breakers 31-32.

As an alternative to having the length of slot 36 control the sidewise movement of lockout 10, the embodiment shown in FIG. 4 can be utilized. In this embodiment, an extension 34A to portion 34 extends to a location between the top and bottom of lever 38. The side edges 45 and 46 of extension 34A therefore control the right and left limits of the movement of lockout 10A such that either circuit breaker 30 or circuit breakers 31 and 32 can be activated at any one time. In this manner, the embodiment of FIG. 4 performs the same function as the embodiment of FIG. 3.

FIG. 5 shows a different embodiment of the lockout 10 of FIG. 3. In this embodiment of the lockout 10B, the depending portions 34B and 35B are angled slightly outward or away from the plane of the upper planar portion 47 of lockout 10B and therefore away from plane of the electrical box cover plate 26. Such angling is provided in order to provide space behind the depending portions 34B and 35B in order to physically clear the circuit breakers 30, 31, and 32 (which in practice extend slightly outward from cover plate 26) when the lockout 10B is moved between its left and right positions. Additionally, a pair of slots 42B are used in place of the single slot 36 of the embodiment of FIG. 3.

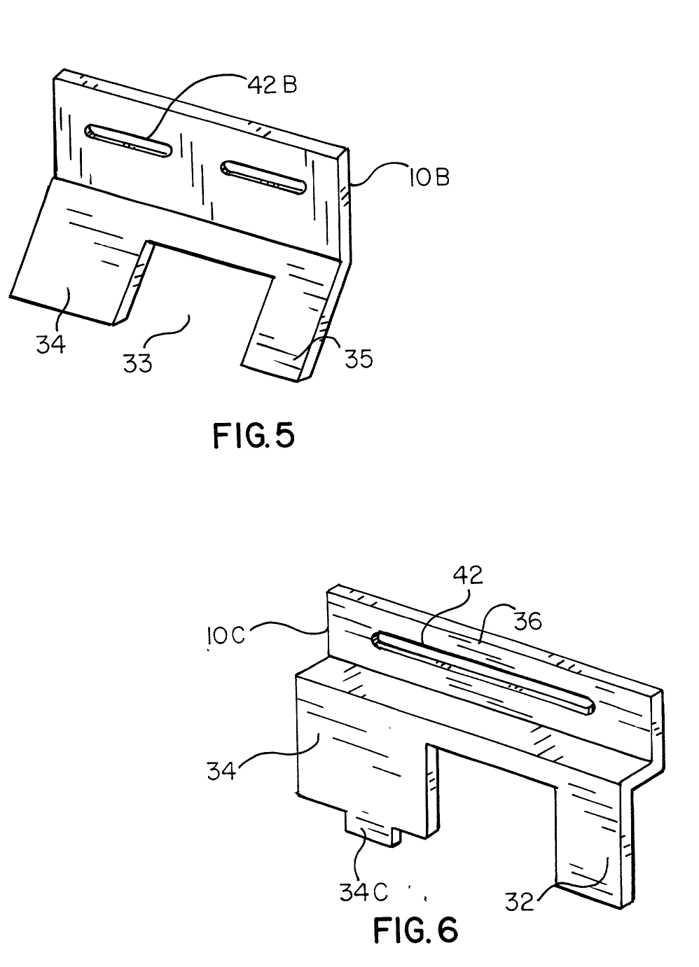

FIG. 6 illustrates an alternative embodiment 10C to the lockout embodiment of 10A of FIG. 4. In this embodiment, a stepped portion 47 is provided between the upper planar portion 36 and the depending portions 34 and 35. The stepped portion 47 locates the depending portions 34 and 35 away from the plane of the cover plate 26 and thereby provides the space needed to clear circuit breakers 30, 31, and 32 which, in practice, extend slightly outward form the plane of the cover plate 26.

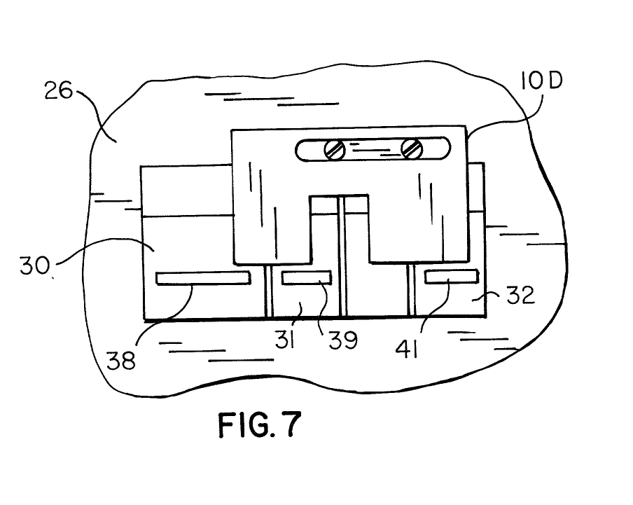

It is to be noted that the various features of the locking plates 10, 10A, 10B, and 10C described above, can be combined in a number of different ways in achieving the resulting lockout of one or more circuit breakers relative to one or more other circuit breakers so as to not overload the feed wire 14 when the total rating of the plurality of circuit beakers exceed the total rating of feed wires 14. For example, the lockout 10D of FIG. 7 provides an arrangement where only one of the circuit breakers 30, 31, or 32 can be activated at any one time. In the embodiment of FIG. 7, a mid position of the lockout 10 allows only circuit breaker 31 to be activated. When lockout 10D is positioned to the right, only circuit breaker 30 can be activated. When lockout 10D is positioned to the left, only circuit breaker 32 can be activated.

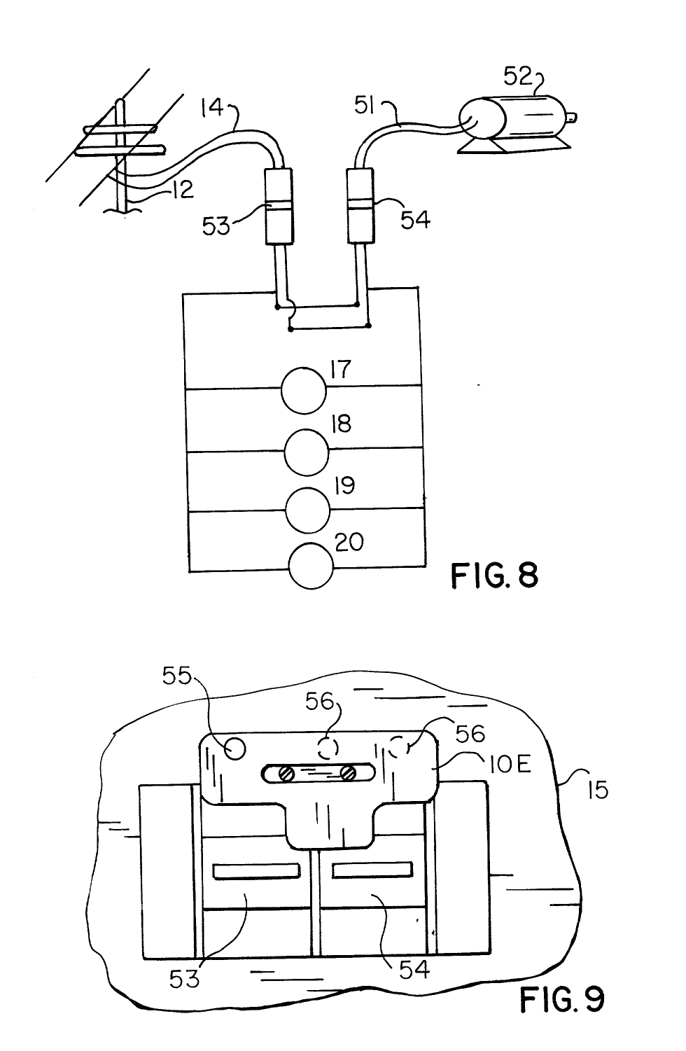

FIG. 8 illustrated an electrical arrangement whereby one or more individual circuits 17, 18, 19, and 20 are powered by either utility power lines 14 or by backup power lines 51 connected to a backup generator 52. In this example, it is desired to activate either circuit breaker 53 or circuit breaker 54, but not both. The inventive lockout can also be used for this purpose, as shown in FIG. 9.

In FIG. 9, the two circuit breakers 53 and 54, which can have the same power rating, are arranged side by side in an electrical box 15. The lockout 10E can be slidingly moved to the left or to the right. When positioned to the right, the depending portion 57 blocks the activation of circuit breaker 54 and only circuit breaker 53 can be activated and thus, the individual circuits 17-20 are supplied power form the utility pole 12. When lockout 10E is moved to the left of that shown in FIG. 9, circuit breaker 53 is locked out by depending portion 57 and only circuit breaker 54 can be activated. In the latter instance, power to the individual circuits 17-20 is supplied by the backup generator 52. At any intermediate position of lockout 10E, neither circuit breaker 53 or 54 can be activated. The physical arrangement of lockout 10E is consistent with the previous embodiments such that either the slot 36 or a further depending portion 57E of lockout 10E can be used to limit the movement of lockout 10E. Should it be desired to fixedly prevent the lockout 10E from inadvertent movement, a removable pin 55 in conjunction with a plurality of appropriately located holes 56 in the lockout 10E and the electrical box 15 can be provided as shown in FIG. 9. Other such devices to prevent inadvertent movement are readily envisioned by one skilled in the art and are therefore intended to be included within the scope of the present invention.

Similarly, any known means to effectuate the sliding or moving motion of the lockout 10 and any known means to allow a depending portion to clear the circuit breakers are intended to be included within the scope of the present invention. Even further, the inventive lockout is not intended to be used only with circuit breakers. The inventive lockout can for example, be used with a plurality of electrical or mechanical switches or devices where it is desired to lockout one or more of such devices while allowing activation of one or more of other of such devices.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breadth and scope of the claims here appended.

### I claim as my invention:

1. Lockout apparatus adapted to be used with one or more switchable electrical devices comprising
a planar member having one or more first portions depending from a common second portion,
said one or more first depending portions being configured and positioned to physically interfere with the switchability of at least one of said switchable devices.

2. Lockout apparatus adapted to be used with a plurality of switchable electrical devices comprising
a planar member having one or more first portions depending from a common second portion,
said one or more first depending portions being configured to physically interfere with the switchability of at least one of said switchable devices,
said one or more depending first portions being positionable to a first position to prevent switching of at least a first one of said switchable devices and to allow switching of at least a second one of said switchable devices, and said one or more depending first portions are positionable to a second position to allow switching of said at least a first one of said switchable devices and to prevent switching of said at least a second one of said switchable devices.

3. The lockout apparatus of claim 2 wherein said at least one depending portion comprises one depending portion

4. The lockout apparatus of claim 3 wherein said one depending portion includes a second portion depending therefrom.

5. The lockout apparatus of claim 2 wherein said lockout apparatus includes two depending portions with a space therebetween.

6. The lockout apparatus of claim 5 wherein at least one of said two depending portions includes a second portion depending therefrom.

7. The lockout apparatus of claim 2 wherein said one or more depending first portions are angled away from a plane of said common portion.

8. The lockout apparatus of claim 2 wherein said one or more depending first portions lie in a plane spaced from a plane of said common portion.

9. The lockout apparatus of claim 2 including means for slidingly positioning said lockout apparatus from said first position to said second position.

10. The lockout apparatus of claim 9 wherein said means for sliding said lockout apparatus comprises one or more slots in said common portion.

11. Lockout apparatus in combination with electrical circuit breakers comprising
a lockout member having a common planar portion and one or more planar depending portions,
one or more electrical circuit breakers, each having a moveable lever for activating and deactivating said one or more circuit breakers,
said lockout member being positionable between at least two positions relative to said one or more circuit breakers, whereby one of said two positions of said lockout member positions said one or more depending portions to interfere with movement of the lever of at least one of said circuit breakers and said second of said lockout positions allows movement of said lever of said at least one of said circuit breakers.

12. The lockout apparatus of claim 11 wherein at least one depending portion includes a second portion depending therefrom.

13. The lockout apparatus of claim 11 wherein said lockout apparatus includes two depending portions with a space therebetween.

14. The lockout apparatus of claim 13 wherein at least one of said two depending portions includes a second portion depending therefrom.

15. The lockout apparatus of claim 11 including means for slidingly positioning said lockout apparatus from said first position to said second position.

16. The lockout apparatus of claim 15 wherein said means for sliding said lockout apparatus comprises one or more slots in said common portion.
